(19) United States
(12) Patent Application Publication
(10) Pub. No.: US 2012/0173641 A1
(43) Pub. Date: Jul. 5, 2012

(54) METHOD OF TRANSFERRING DATA BETWEEN END POINTS IN A NETWORK

(75) Inventor: Peter DAHLSEIDE, Skiptvet (NO)

(73) Assignee: IRX - INTEGRATED RADIOLOGICAL EXCHANGE, Oslo (NO)

(21) Appl. No.: 13/340,150

(22) Filed: Dec. 29, 2011

Related U.S. Application Data
(60) Provisional application No. 61/428,319, filed on Dec. 30, 2010.

(51) Int. Cl. G06F 15/16

(52) U.S. Cl. 709/206; 709/217

(57) ABSTRACT

A method and a computer system for transferring data between a first end point and a second end point in a network. The first end point has access to one or more communication servers for sending data and the second end point is represented by one or more communication addresses associated with one or more communication servers for receiving data. One or more communication addresses representative of the second endpoint is received at the first end point. It is then determined whether at least one of the received communication addresses is associated with at least one communication server to which the first endpoint has access. If a positive determination is made, data is transmitted from the first end point using a selected communication server to which the first end point has access and a communication address representing the second end point and associated with said selected communication server.

### CROSS REFERENCE TO RELATED APPLICATION

The present application claims priority to copending U.S. Provisional Application No. 61/428,319 filed on Dec. 30, 2010, the entire contents of which are incorporated herein by reference in their entirety.

### FIELD OF THE INVENTION

The present invention relates to transfer of data between end points in a network. In particular, the invention relates to transfer of large data amounts in networks where load balancing and data security and integrity are important.

### BACKGROUND OF THE INVENTION

Sophisticated technologies for data transfer have largely been developed with a focus on lower level functionality such as switching, routing, and error correction. Protocols that handle data transfer at these levels utilize, e.g., packet switching, error correction using checksums at packet level, and individual routing at packet level. Higher level functionality, particularly at the application and presentation layers, have not addressed issues of routing or load balancing in the network. At the same time issues like data security and integrity are routinely handled at the higher levels through protocols handling encryption, authentication, and authorization.

Certain applications, such as the transfer of large data amounts where data security is a major issue, may be inadequately handled at the lower levels of the network and transport layers when it comes to efficient routing and load balancing in the network. Reasons for this may include restrictions on the sending or the receiving end point regarding when and how data may be transmitted or received, capabilities on the presentation or application layers with respect to interrupted and resumed transfers, and the handling of different priorities.

Email protocols such as simple mail transfer protocol (SMTP), post office protocol (POP), and Internet message access protocol (IMAP) represent mature technologies that are well known to people with skill in the art of data communication. These protocols are well suited for transfer of small and medium amounts of data since the person sending the data only needs to know the email address of the recipient. Confidentiality of the data can be protected through data encryption, and the recipient does not have to allow the sender of the data to access their own computer systems. Instead, data is transferred to an email server from which the recipient downloads the information. However, email protocols are not convenient for large data amounts, since there are no mechanisms for resuming an interrupted data transfer. In particular, there is no way of interrupting a transfer of large messages in order to prioritize messages with a higher priority. Email protocols are particularly rigid when the sender and the receiver have email accounts on different servers, i.e., the outgoing server and the incoming server are not one and the same, which is most often the case.

Other well-known technologies such as the file transfer protocol (FTP) suffer similar shortcomings.

A need has therefore been identified for improving efficiency and security when large data amounts are transferred between end points in a data network.

### SUMMARY OF THE INVENTION

According to a first aspect of the present invention, a method of transferring data between a first end point and a second end point in a network has been provided. The first end point may have access to one or more communication servers for sending data, and the second end point may be represented by one or more communication addresses associated with one or more communication servers. Data sent to a given address can typically be downloaded or received from the server with which that address is associated.

The first end point may receive, prior to the initiation of data transfer or as a result of the initiation of a data transfer session, one or more communication addresses representative of the second end point. It may then be determined whether at least one of the received communication addresses is associated with at least one communication server to which said first endpoint has access. If a positive determination is made, data can be transmitted from the first end point using a selected communication server to which the first end point has access, and a selected communication address representing said second end point and associated with the selected communication server.

According to one aspect of the invention, the data to be transmitted may be divided into a plurality of blocks prior to transmission, each block may be associated with a sequential number, and each block may be transmitted as an individual message.

According to another aspect of the invention, a checksum representative of the transmitted data can be generated and transmitted to the second end point.

When the data is divided into blocks, checksums can be generated and transmitted to the second end point for each block. These alternatives are, of course, not mutually exclusive, and it is consistent with the principles of the invention to generate one checksum for each block and one checksum for all the transmitted data.

According to some embodiments of the invention, the addresses are email addresses, and the data is transmitted as one or more email messages.

According to other embodiments of the invention, the addresses represent FTP accounts and said the data is transmitted as one or more FTP uploads.

Other alternatives are, of course, also contemplated and within the scope of the present invention.

According to yet another aspect of the invention, if a negative determination is made when determining whether the first end point has access to a server with which the second end point has an associated address, the method may further comprise requesting access for said first end point to at least one of the communication servers with which at least one of the received addresses is associated. If such access is granted, data can be transmitted from the first end point using a selected communication server to which access has been granted, and a communication address representing the second endpoint and associated with the selected communication server.

According to an alternative aspect of the invention, if a negative determination is made the method may further comprise requesting establishment of a communication address representing the second end point and associated with at least one of the communication servers to which the first end point has access. Upon receiving at least one established communication address representing the second end point and associated with at least one of these servers, data can be transmitted from the first end point using a received address representing the second endpoint, and a communication server with which the received address is associated.

It should be noted that these alternative aspects are not mutually exclusive. In some embodiments of the invention only one of these alternatives may be implemented. However, in other embodiments of the invention, both alternatives may be implemented, allowing one to be selected and performed according to circumstances. Other embodiments may not only implement both alternatives, but perform both alternatives, and the decision to grant access for the first endpoint, create a new address for the second endpoint, or perhaps both, may for example be made by an administrative server, as described below.

A computer system implementing aspects of the invention may include a first computer representing the first endpoint, a second computer representing the second endpoint, and one or more communication servers. The first computer may include at least one processor and a computer-readable medium upon which is stored instructions executable by said processor, enabling the processor to receive one or more communication addresses representative of the second end point computer, and determine whether at least one of the received communication addresses is associated with a communication server to which the first endpoint computer has access. The processor may then, if a positive determination is made, transmit data from the first end point computer to a selected communication server to which the first end point computer has access. A communication address representing the second end point computer and associated with the selected communication server may be included with the data.

The instructions on the computer-readable medium may further include instructions enabling the processor to, if a negative determination is made, request access for the first end point computer to at least one of the communication servers with which at least one of the received addresses is associated, and if access is granted, transmit data from the first end point computer using a selected communication server to which access has been granted, and a communication address representing the second endpoint computer and associated with the selected communication server.

The instructions on the computer-readable medium may also, or alternatively, include instructions enabling the processor to, if a negative determination is made, request establishment of a communication address representing the second end point computer and associated with at least one of the communication servers to which the first end point has access, receive at least one established communication address representing the second end point computer and associated with at least one of these servers, and transmit data from the first end point computer using a received address representing the second endpoint computer and a communication server with which the received address is associated.

According to another aspect of the invention, a system consistent with the principles of the invention may include at least one administrative server computer with at least one processor and a computer readable medium upon which is stored instructions executable by said processor. These instructions may enable the processor to receive data identifying a first endpoint computer and a second endpoint computer, and perform at least one of: (i) identifying a communication server with which the second endpoint has an associated address for receiving data, and providing access from the first endpoint computer to that communication server for sending data; (ii) identifying a communication server to which the first endpoint computer has access for sending data, and providing the second endpoint computer with an address associated with that server for receiving data; and (iii) selecting a communication server, providing the first endpoint computer with access to the selected communication server for sending data, and providing the second endpoint computer with an address associated with the selected communication server for receiving data.

The data received by the administrative server identifying a first and a second endpoint computer may be a request sent from one of the first and the second endpoint computers. The data may include an explicit request, and that request may indicate whether one of the three alternatives listed above are preferred. Alternatively, the decision as to which of the alternatives to perform may be determined by the administrative server, for example based on a desire to achieve overall load balancing and avoid traffic congestion in the network as a whole.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein

FIG. 1 illustrates a computer network where two end point computers may communicate in accordance with the invention;

FIG. 2 is a flowchart illustrating a method according to the invention;

FIG. 3 is a flowchart illustrating an aspect of a method according to the invention;

FIG. 4 is a flowchart illustrating another aspect of a method according to the invention;

FIG. 5a-5d are diagrams illustrating alternative flows of requests, responses, and data between nodes in a computer network;

FIG. 6 illustrates a computer network of end point computers, communication servers and administrative servers operating in accordance with the invention.

### DETAILED DESCRIPTION OF EXEMPLARY EMBODIMENTS

The present invention is directed to the transfer of data between end points in a computer network. According to the present invention, an end point having access to a plurality of outgoing servers for sending data may determine whether a recipient of the data has an address associated with one of the possible outgoing servers, and if this is the case cause the data to be transmitted using this server.

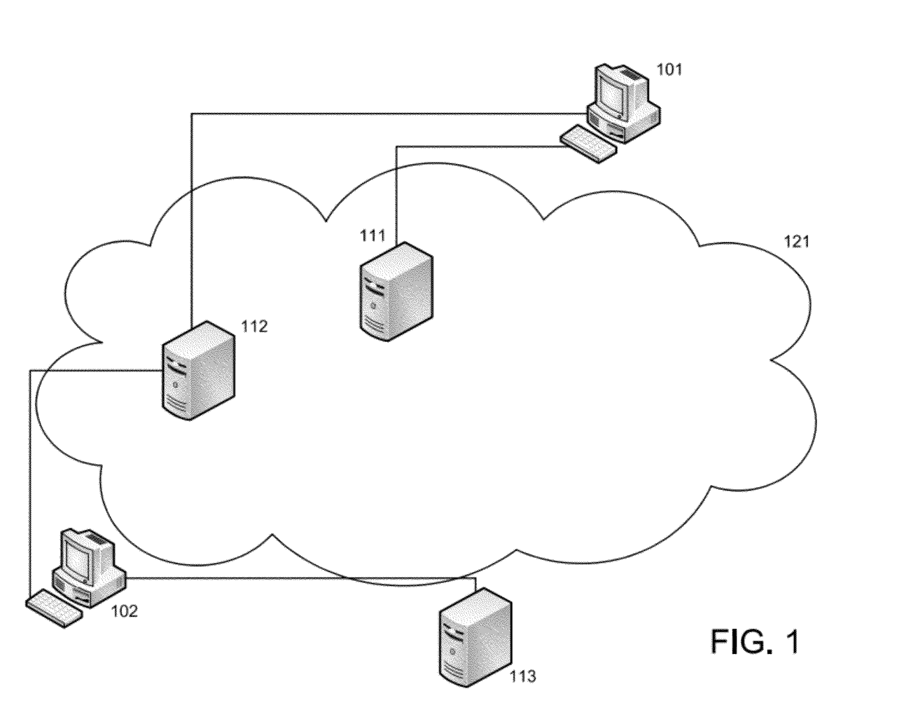

FIG. 1 illustrates a computer network including two endpoints 101, 102, which may for example be personal computers or workstations. However, endpoints 101, 102 may also represent a Local Area Network (LAN), a local mail server, a router/firewall, or some other data repository. Also shown are three communication servers 111, 112, 113 and a network cloud 121. The network 121 may, for example, be the Internet or some other wide area network (WAN). It may be assumed that all the illustrated computers are connected to the network 121 and capable of communicating over the network using standard communication protocols, such as transmission control protocol/internet protocol (TCP/IP), FTP, hypertext transfer protocol (HTTP), etc. In addition, the endpoints are shown as directly connected to some of the message servers. In particular, endpoint 101 is shown as being directly connected to communication server 111 and communication server 112, while endpoint 102 is shown as being directly connected to communication server 112 and communication server 113.

The direct connections should not, however, be interpreted as direct physical connections. Rather, the direct connections represent associations between the endpoints and the server. The actual data transfer between an endpoint and a communication server may still be performed over the wide area network 121.

Consistent with principles of some embodiments of the invention, an endpoint may be associated with a communication server in two different ways. First, an endpoint may be represented by an address for receiving data, and that address will be associated with a communication server. Data sent to an endpoint using a given address may be sent to the server with which the address is associated and downloaded by the receiving endpoint from that server. Secondly, an endpoint may be represented by an account for sending data, and that account will also be associated with a communication server. In order to be able to send data, an endpoint must be represented by at least one account of at least one server, and in order to receive data the endpoint must be represented by at least one address of at least one server.

A word on terminology may be in order at this point. In the description of the invention, account will be used to refer to the access an endpoint has to a server for outgoing data transfer, while address will be used to refer to the designation of a particular recipient endpoint. This terminology is chosen for convenience and should not be interpreted to imply that an address may not be part of an account, for example, an email account or an FTP account. Similarly, an account with a communication server for outgoing data transfer means that the endpoint has access to a given server, for example an SMTP server, for sending data. The account may, but does not have to, include aspects that are normally thought of as part of an account, such as a username and a password. It may be sufficient that the endpoint actually is able to access the communication server, and transfer data to the communication server for further transfer to the receiving endpoint.

According to some embodiments, an account for sending data and an address for receiving data may be designated in pairs, such that an endpoint always has an outgoing account on a server on which it has an incoming address, but this is not a necessary requirement. For the sake of simplicity, however, the examples may assume that an association, or direct connection, between an endpoint and a communication server is symmetrical in the sense that it represents a possibility of sending as well as receiving data. This simplification can be done without loss of generality, and is not intended to imply any restriction or limitation on the invention. The principles of the invention apply also to embodiments where incoming addresses and outgoing accounts do not share association with a common communication server, as will be readily understood by those with skill in the art.

Returning, then, to the example illustrated in FIG. 1, it will be assumed that endpoint 101 is able to receive data at addresses associated with server 111 and server 112, and also send data using outgoing accounts at either of those two servers. It will also be assumed that endpoint 102 can receive data at addresses, and send from accounts, that are associated with server 112 and server 113.

According to a first exemplary embodiment, the addresses for receiving data are email addresses, and the accounts for sending data are email accounts. The invention is, however, not limited in this respect.

Using well-established methods for email exchange, if a user at endpoint 101 desires to send data to a user located at endpoint 102, the data will be sent using an email address representing endpoint 102, and endpoint 101 will use an outgoing email server to send the data. No effort will be made to select among several outgoing servers or several addresses. Consequently, in a typical situation data may be sent from endpoint 101 to communication server 111 where it is queued for delivery to communication server 113. The data will not be sent until all other outgoing data messages ahead in the queue have been transmitted; there is normally no way to prioritize a message by moving it to the head of the queue. When the data is finally transmitted, it will be routed through the network to communication server 113. If something goes wrong during data transfer (such as data corruption, connection timeout, or memory overflow anywhere in the data's path on its way from communication server 111 to communication server 113), any data already transferred will be lost and there are no mechanisms to resume the transfer. In other words, the entire transmission must be repeated from the beginning. Also, there is typically no way to prioritize incoming messages. This means that if server 113 is busy receiving other incoming messages on all available communication ports, transfer of the message must wait until a port is available.

After all the data has been received at the receiving server 113, a user at the destination endpoint may access the message by downloading it from the server 113.

According to a first aspect of the present invention, this situation is alleviated by letting each end point be represented by one or more addresses for receiving data and one or more accounts for sending data, each address and each account being associated with a communication server system. When data is ready to be transmitted from one endpoint to another, the transmitting endpoint can then select an outgoing server that can also operate as an incoming server for the receiving endpoint. According to the example in FIG. 1, endpoint 101 may select server 112 to send data to endpoint 102.

By doing this, data will not have to be transferred between message servers. As soon as the data has been received by the server 112, it can be made available for download to client 102. It is not necessary to queue the data for transmission to intermediate message servers, and it will be possible for the receiving client 102 to access incoming data based on priority.

According to a second aspect of the invention, messages can be divided into a plurality of messages that are sent individually. The principle is well known from packet switching and related communication methods. However, according to the present invention, it is proposed to perform the subdivision at a higher layer in the communication protocol stack, typically at the application layer. The subdivision may then be performed not in the network as a part of the data transfer process, but by the transmitting application prior to transmission. Furthermore, the individual sub-messages may then be associated with checksums or some other form of error control, and they may be sequentially numbered. In that manner, the receiving application will be able to detect errors in individual sub-messages or missing sub-messages, and request retransmission of individual sub-messages. Consequently, resume capabilities can be introduced even when using transmission protocols that do not provide such capabilities.

It should be noted that the method does not necessitate that either endpoint opens their local system to access from the other endpoint, as the case often may be when entities need to transfer large amounts of data between each other. Endpoint 101 does not need to open any port in order to allow endpoint 102 to access and download any data, and endpoint 102 does not need to open any port in order to allow endpoint 101 to upload any data to the receiving system.

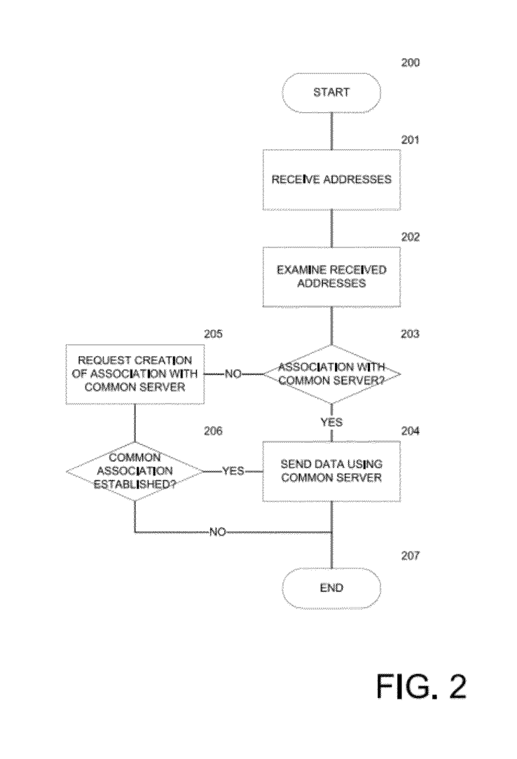

Reference is now made to FIG. 2, which is a flowchart illustrating a process of sending data from one endpoint to another in accordance with an embodiment of the invention. The various steps of processing, examining, comparing, and determining may be performed using one or more processors in the endpoint 101.

The process starts in an initiating step 200 where it may be established that one endpoint 101 is in possession of data that should be transmitted to another endpoint 102. The process then moves to step 201 where available addresses of receiving endpoint 102 are received by transmitting endpoint 101. The method used for transferring the addresses to endpoint 101 is not crucial, since the amount of data necessary for representing addresses is negligible. Among the alternatives contemplated by the present invention are sending a message using the invention itself (provided endpoint 102 has already received representative addresses of endpoint 101), sending an email message to a regular email address outside the system of the invention, downloading a list of addresses from a web server or a directory server, and even entering the addresses manually. The addresses may also already be present in endpoint 101, for example stored in memory after having been received for example as part of a previous transmission of data from the first endpoint 101 to the second endpoint 102. If this is the case, the addresses will be received from the memory wherein it has been stored.

After the addresses of the receiving endpoint 102 have been received, the process moves on to a next step 202 where the received addresses are examined and their association with communication servers are determined. In the next step 203, the communication servers of the available addresses are compared with a list of communication servers available as outgoing servers, and it is determined whether any association with a common server exists. According to the example illustrated in FIG. 1 and using email addresses, the received addresses may include:

endpoint102@server112.com

endpoint102@server113.com

A list of available outgoing servers for the transmitting endpoint 101 may include: server111.com server112.com.

Consequently, according to this example, step 203 will determine that there is a common association with server112.com.

The process will then move on to step 204 where data is transmitted using the server and address determined in step 203. In the example of FIG. 1, this means that endpoint 101 uses server 112 to send data to the address endpoint102@server112.com. The process then ends in a final step 207.

According to some embodiments of the invention, the system is static, and if no common server is found in step 203, it is determined that the data cannot be transmitted, or that it is necessary to fall back to a method that uses intermediate servers in order to reach the destination endpoint.

However, consistent with the principles of the invention, the method allows for dynamic creation of new associations. Consequently, if in step 203 it is determined that there is no association with a common server, the process may move on to step 205 where it is requested that a new association is created. This may either be a request that the transmitting endpoint establishes an account for sending messages with a server with which the receiving endpoint has an address, i.e., with a server associated with one of the received addresses. Alternatively, it may be requested that the receiving endpoint establishes an address with a server with which the transmitting server has an account for sending data.

If it can be determined in a next step 206 that a common association has successfully been established, the process moves on to step 204 and the data is sent as described above. If, however, it is determined that the attempt at establishing a common association failed, it is determined that the data cannot be transmitted, or that it is necessary to fall back to a method that uses intermediate servers in order to reach the destination endpoint. The process then ends in final step 207.

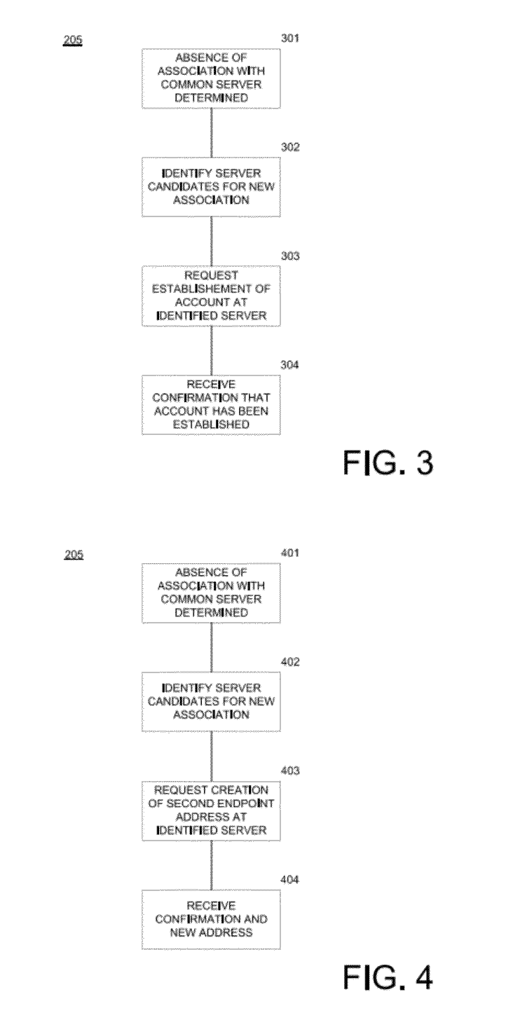

Reference is now made to FIG. 3, which illustrates a first embodiment of how the process of requesting creation of association with a common server 205 may be performed. According to this embodiment, the endpoint attempts to establish new outgoing accounts. In a first step 301, it has been determined that there is no association with a common server. In other words, the transmitting endpoint 101 has received a list of addresses for the receiving endpoint 102, none of which are associated with a server which can be used by the server 101 to transmit data. In a next step 302, servers that are candidates for establishment of a new account are identified from the list of received addresses. One or more requests are then sent out 303 to one or more of the servers that were identified. Finally, confirmation that an account has been established is received from one or more servers in a step 304. Of course, if no such confirmation is received, this will be determined in step 206 as illustrated in FIG. 2. After receiving confirmation that one or more new accounts have been established, the endpoint 101 is configured to use the new server or servers, and the process illustrated in FIG. 2 moves to step 206, and then to step 204, as described above.

All the steps illustrated in FIG. 3 may be performed locally at the endpoint. Alternatively, the necessary steps for determining which server or servers are candidates for establishing new outgoing accounts may be performed by an administrative server on behalf of the endpoint 101. This will be discussed in further detail below.

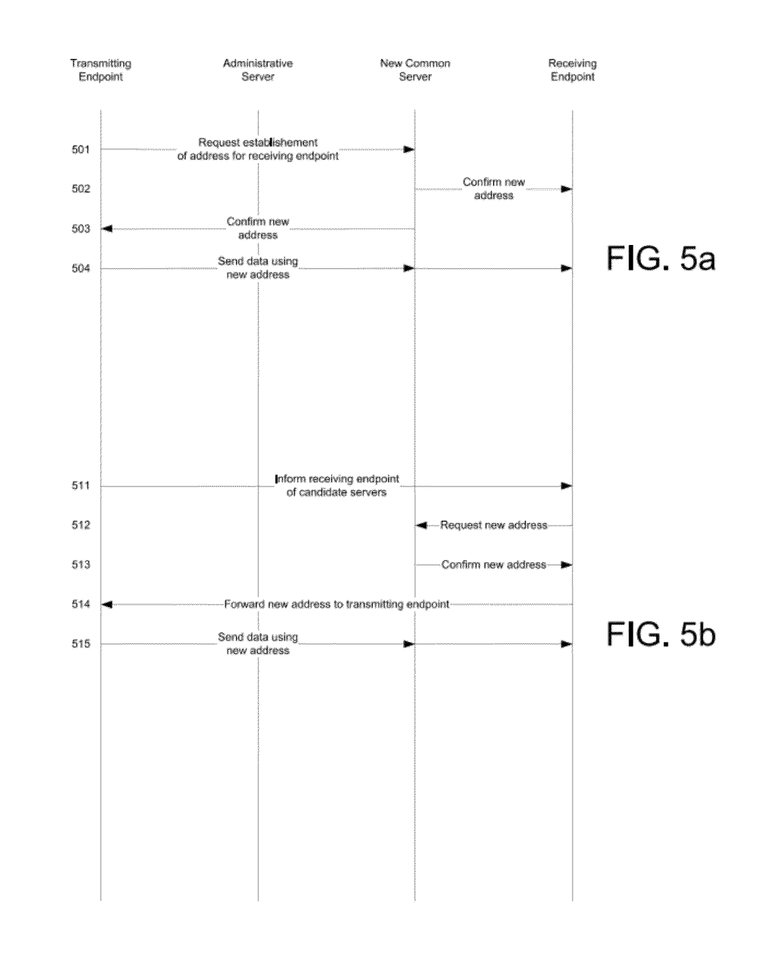

According to an alternative embodiment of the invention, illustrated in FIG. 4, the sub-process 205 of requesting the creation of an association with a common server may include the establishment of new incoming addresses for the receiving endpoint 102. According to this embodiment, the absence of an association with a common server has been determined in a step 401. In a next step 402, server candidates for establishment of new incoming addresses for the receiving endpoint 102 are identified. One or more requests to create new addresses are created and transmitted to the identified server or servers in a step 403. Finally, confirmation that an account has been established is received from one or more servers in a step 404. In this case, both endpoints must receive such confirmation. Endpoint 101 must receive the new addresses in order to be able to continue to step 204 of FIG. 2, and endpoint 102 must be configured to receive data from the new server or servers. Of course, if no such confirmation is received, this will be determined in step 206 as illustrated in FIG. 2.

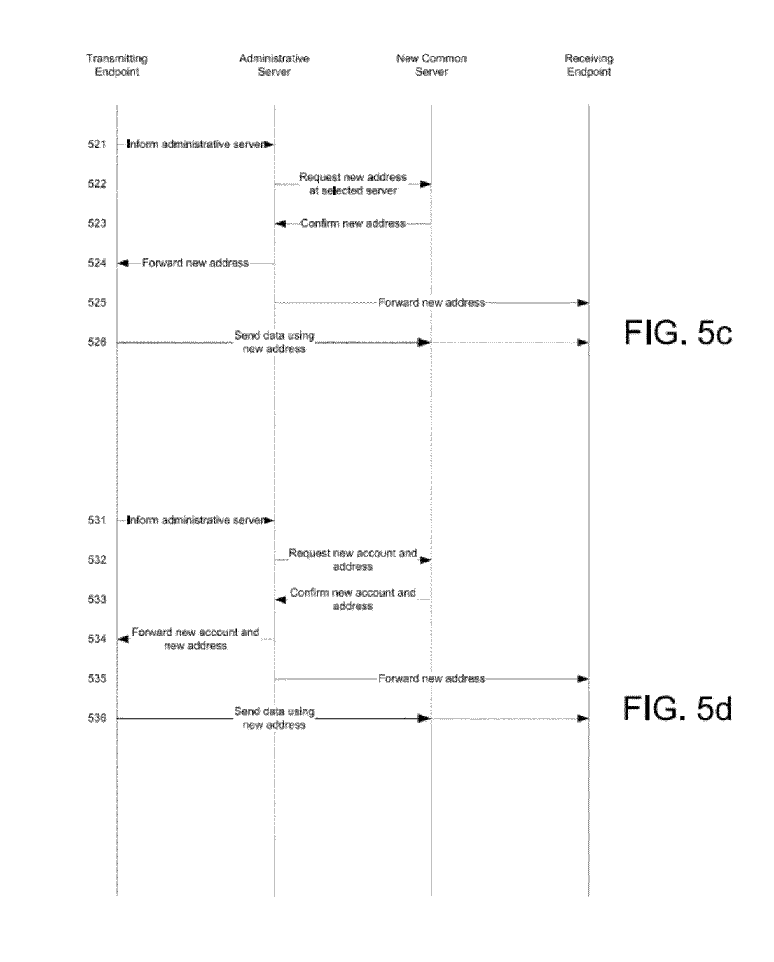

As opposed to the alternative illustrated in FIG. 3, which does not necessarily have to involve the receiving endpoint 102, the alternative embodiment illustrated in FIG. 4 must at the very least enable the receiving endpoint 102 to start receiving data from the new server using the new incoming address. Several alternative embodiments are possible within the scope of the invention. Four such alternatives are illustrated in FIG. 5

A first alternative is illustrated in FIG. 5a, which illustrates how, after establishing that no common server exists, the transmitting endpoint in step 501 sends a request for establishment of a new receiving address for the receiving endpoint to one of the servers where the transmitting endpoint has an account. After creating the new address, the new common server sends a confirmation of the new address to the receiving endpoint and to the transmitting endpoint in respective steps 502 and 503. After receiving the new address, the transmitting endpoint can transmit data to the receiving endpoint over the common server using the new address in step 504.

A second alternative is illustrated in FIG. 5b. According to embodiments using this alternative, the transmitting endpoint in step 511 informs the receiving endpoint that no common association with a server exists. The information sent to the receiving endpoint should also identify one or more servers at which the transmitting endpoint has an account. The transmitting endpoint may then request creation of a new address at a server identified by the transmitting endpoint in a step 512. According to this example, the server creates the new address, and sends a confirmation including the new address back to the receiving endpoint in step 513. The receiving endpoint then forwards the received address to the transmitting endpoint in step 514. Alternatively, the server could be responsible for transmitting the newly created address to both endpoints as in the example illustrated in FIG. 5a. Finally, after receiving the new address the transmitting endpoint can transmit data to the receiving endpoint over the common server using the new address in a step 515.

A third alternative is illustrated in FIG. 5c. According to embodiments using this alternative, an additional type of system component is involved. This component will be referred to as an administrative server, and it will be described in further detail below.

In a first step 521, after having established the fact that no common association with a server for sending and receiving data, respectively, exists between the sending and the receiving endpoints, the transmitting server sends a message to the administrative server with information regarding this situation. This information may include a list of servers with which the transmitting endpoint has an account for sending data.

After receiving this information, in a next step 522, the administrative server identifies one or more servers at which a new address for the receiving endpoint should be created and sends a request that this should be done to the identified server or servers. After confirmation that the address has been created is received from the server or servers in step 523, the administrative server forwards the new address to the transmitting endpoint and the receiving endpoint in respective steps 524, 525. After receiving the new address the transmitting endpoint can transmit data to the receiving endpoint over the common server using the new address in a step 526.

The example illustrated in FIG. 5c represents an alternative where a new address for the receiving endpoint is created. However, the administrative server may have additional information, for example, about the traffic loads in various parts of the network, and determine that it is preferable in a given situation to create a new outgoing account for the transmitting endpoint rather than creating a new address for the receiving endpoint. In order to make this determination, the administrative server may need a list of outgoing servers for the transmitting endpoint, and a list of addresses for the receiving server. This information may already be stored in the administrative server, which may, e.g., also function as a directory server, or it may be sent to the administrative server with the information received in step 521. In addition, the administrative server will need data regarding the traffic situation in the network, at least locally.

According to some embodiments where the administrative server is able to determine whether a new account should be established for the transmitting endpoint or a new address should be created for the receiving endpoint, the administrative server may also be able to determine that, based on an evaluation of traffic load in the network, it would be better to use a new common server with which neither the transmitting endpoint or the receiving endpoint already has an association. FIG. 5d illustrates the progress of data flow in an alternative embodiment where a new server is introduced in order to create the association. In a first step 531, the transmitting endpoint informs the administrative server that it desires to send data to the receiving endpoint but that no common association with a server exists. Based on this information the administrative server, according to this example, determines that it is most preferable to create a new association at a communication server at which the transmitting endpoint does not already have an account, and at which the receiving endpoint does not already have an address. After determining the server where the new association should be created, the administrative server sends a request to that server in step 532. The request includes a request that that a new account is created for the transmitting endpoint and that a new address is created for the receiving endpoint. After the account and the address have been created, confirmation is returned to the administrative server in step 533. Alternatively, the confirmation could be sent directly to the endpoints involved.

When the administrative server receives the necessary data regarding the new account and the new address, information regarding both is sent to the transmitting endpoint in step 534. The transmitting endpoint will need information regarding the new account created on its behalf in order to use the new server to transmit data, and it will also need the new address created on behalf of the receiving endpoint in order to use the new address when transmitting data. The receiving endpoint only needs information regarding the new address created on its behalf in order to be able to properly receive data from the new common server. Information regarding the new outgoing account for the transmitting endpoint is generally not needed at the receiving end, and thus may be omitted from information sent to the receiving endpoint. Thus, information regarding the new address is sent from the administrative server to the receiving endpoint in step 535. Finally, in step 536, the transmitting endpoint uses the new account to send data over the new common server using the new address for the receiving endpoint in a step 536.

Consistent with the principles of the invention the administrative server may be located together with one of the endpoints; it may even be running on the same hardware as one of the endpoints. Alternatively, it may be located at a different location in the network. Also, the task of the administration server may be distributed between several servers, as will be discussed in further detail below.

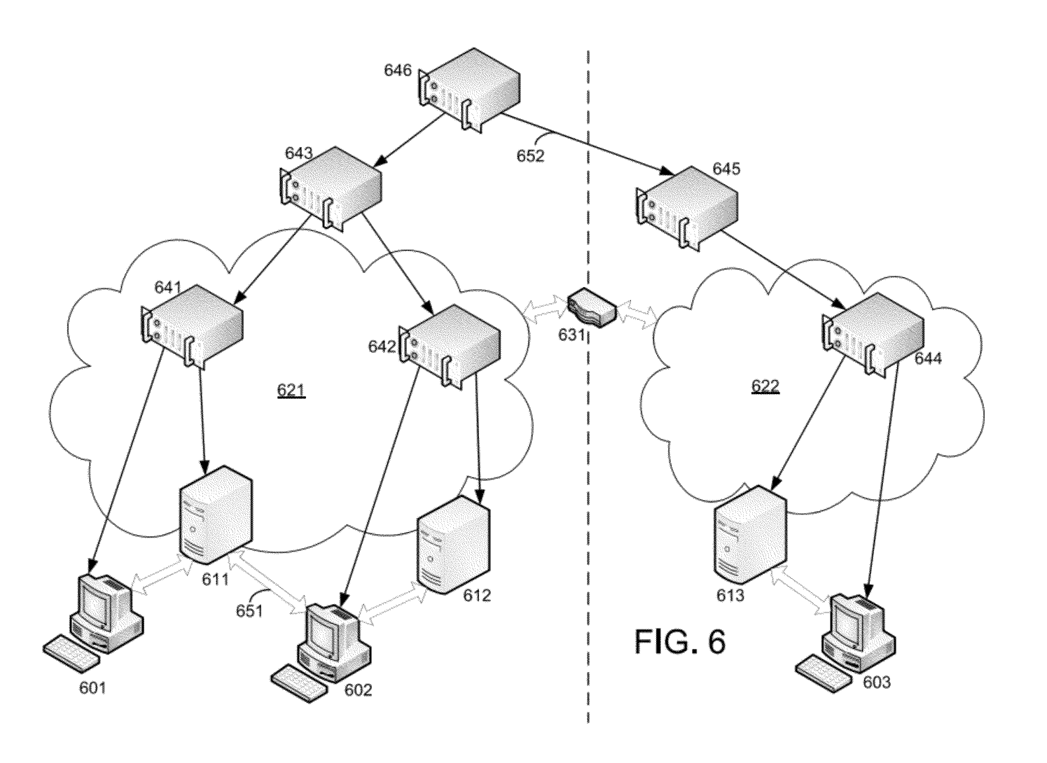

Reference is now made to FIG. 6, which illustrates a network of endpoints 601, 602, 603, communication servers 611, 612, 613 and administrative servers 641, 642, 643, 644, 645, 646. The various computers communicate over two networks generally indicated as two network clouds 621, 622. Finally a number of arrows indicate the relationship between various components.

Double arrows, such as the one indicated by reference numeral 651, represent a relationship between an endpoint and a communication server wherein the endpoint has an account for sending outgoing data and an address for receiving incoming data at that communication server. It should be noted that while this example is based on symmetrical accounts in the sense that an endpoint has incoming and outgoing accounts at the same server, this is not a necessity and does not have to be the case in other embodiments of the invention.

Single arrows such as the one indicated by reference numeral 652 represent an administrative relationship. An arrow points from an administrative server to another computer which the administrative server is in some sense responsible for administrating. An administrative server may be responsible for administrating other administrative servers, communication servers, endpoints or any combination of these.

It will be noted that endpoint 601 and 602 both have accounts and addresses at communication server 611. In addition, endpoint 602 has an account and an address at communication server 612. If initially endpoint 602 did not have a relationship with communication server 611, and the endpoints 601 and 602 needed to transfer large amounts of data between each other, the method according to the present invention may have been used in order to establish the relationship between endpoint 602 and communication server 611.

However, as described above, administration servers may be used to determine how a lack of common association should be resolved. As the illustration shows, while endpoint 601 and communication server 611 are controlled by administrative server 641, endpoint 602 and communication server 612 are controlled by administrative server 642. Consequently, according to one embodiment of the invention, if either endpoint 601 or 602 sent a request for common association to its administrative server 641 or 642 respectively, that administrative server may not be in a position to resolve the situation. Consequently, the administrative server may pass the request on to its own administrative server 643. When administrative server 643 receives the request, it may first determine whether both endpoints belong in the part of the network this administrative server controls. This is determined in the affirmative according to the current example, and the administrative server 643 may determine that an account and/or an address for endpoint 602 should be created at communication server 611.

In FIG. 6, the two network clouds illustrate that the computers may belong to different networks that may not necessarily be able to pass information back and forth between each other. Router 631 illustrates that data traffic may be able to reach one network from the other, but the router 631 may impose limitations on the traffic that it allows to pass. Consider therefore an example where endpoint 602 is in possession of data that it desires to transfer to endpoint 603. Endpoint 602 may have received an address representing endpoint 603 and its association with communication server 613, e.g., endpoint603@server613.com. Examining this address, endpoint 602 will be able to determine that no common association exists, since endpoint 602 has outgoing accounts at communication server 611 and communication server 612. The situation can be resolved either by giving endpoint 602 an outgoing account at communication server 613, or by giving endpoint 603 an address at either communication server 611 or at communication server 612. Assuming in this example that it is the transmitting endpoint that requests the creation of a common association with a communication server, endpoint 602 will send a request to administrative server 642. It should be noted that while endpoint 602 has an association with communication server 611, which is controlled by administrative server 641, administrative server 641 does not control endpoint 602 directly, and endpoint 602 is not able, according to this example, to send a request to administrative server 641.

When administrative server 642 receives the request from endpoint 602 the request may for example include a table showing the existing associations as shown in Table 1.

TABLE 1

| Requesting endpoint | Receiving endpoint |
|---|---|
| endpoint602@server611.com | endpoint603@server613.com |
| endpoint602@server612.com | |

It will be noted that Table 1, like this entire example, is based on the assumption that outgoing accounts and incoming addresses are assigned symmetrically, which does not have to be the case in other embodiments of the invention.

Based on a directory of its own section of network 621, administrative server 642 may now determine that, while communication server 612 is under its administration, this is not the case with communication server 611 or with communication server 613. Consequently, it will be necessary to forward the request to the next higher administrative server, which in this example is administrative server 643. Upon examining Table 1, administrative server 643 is able to determine that, while it does administrate the entire network 621 including both of the communication servers with which endpoint 602 has an association, endpoint 603 and communication server 613 does not even belong to this network. Consequently, administrative server 643 will need to pass the request on to the next higher administrative server 646, which in this example is the top level server in the hierarchical structure among the administrative servers.

When the top level administrative server 646 receives the request, it may first determine whether the two endpoints in question (endpoints 602 and 603) should be or can be able to communicate with each other despite the fact that they are located in different networks. There may be several reasons why this determination may give a negative result. For example, there may be no physical connection between the two networks; one or both of the endpoints may be prohibited from communicating with endpoints on the other network due to firewall restrictions or other policy restrictions implemented locally at the endpoints or in the gateway between the networks. There may also be policy restrictions implemented in the administrative server itself that determine whether two given endpoints residing in respective networks should be able to communicate.

If the administrative server determines that the two endpoints (in this example endpoint 602 and endpoint 603) are physically able to communicate with a common communication server, and that there are no policy restrictions that prohibits establishment of an association across the two networks, the administrative server must determine which one of the two endpoints should establish an association with a communication server in a different network than the one in which it resides. If the communication system implements only one policy, i.e., either to always establish a new association (outgoing account) for the requesting endpoint or always establish a new association (incoming address) for the receiving endpoint, the result is given. However, the administrative server 646 may make the determination based on policy, for example, only one of the servers may be allowed to be associated with servers in a different network or only one of the networks may allow servers to host accounts for endpoints residing in different networks. The determination may also be made based on a desire to balance the load on different servers. Various strategies for load balancing and traffic distribution are known to those with ordinary skill in the art and will not be discussed in detail here.

According to the present example, the administrative server may thus determine that endpoint 602 should be allowed to establish an association with communication server 613, or that endpoint 603 should be allowed to establish an association with communication server 611 or communication server 612. A third alternative would be to designate a server with which neither of the endpoints already have an association, and allow both endpoints to establish new associations with that server.

It should be noted that the present invention is intended to handle situations where the endpoints do not know how many communication servers there are. Consequently, if a first end point computer receives an address representative of a second end point, it will not assume that the communication servers are shared. The process of determining whether this is the case may be performed, and the results of the determination may be handled in accordance with the invention.

1. A method of transferring data between a first end point and a second end point in a network, the first end point having access to one or more communication servers for sending data and the second end point being represented by one or more communication addresses associated with one or more communication servers, the method comprising:
receiving at the first end point, one or more communication addresses representative of the second end point;
using at least one processor in the first endpoint to:
determine whether at least one of said received communication addresses is associated with at least one communication server to which said first endpoint has access;
if the determination is positive, select a communication server to which said first end point has access and a received communication address which is associated with said selected communication server, and transmit data from said first end point using said selected communication server and said selected communication address.

2. The method of claim 1, wherein said transmission further comprises:
prior to transmitting said data, dividing said data into a plurality of blocks;
associating each block with a sequential number; and
transmitting each block as an individual message.

3. The method of claim 2, wherein said dividing said data into a plurality of blocks is performed at the application layer.

4. The method of claim 2, further comprising:
for each block, generating and transmitting to said second end point a checksum representative of the data in the block.

5. The method of claim 1, further comprising:
generating and transmitting to said second end point, a checksum representative of the data transmitted.

6. The method of claim 1, wherein said addresses are email addresses, and said data is transmitted as one or more email messages.

7. The method of claim 1, wherein said addresses represent FTP accounts and said data is transmitted as one or more FTP uploads.

8. The method of claim 1, further comprising:
if the determination is negative:
request access for said first end point to at least one of said communication servers with which at least one of said received addresses is associated; and
if access is granted, transmit data from said first end point using a selected communication server to which access has been granted and a communication address representing said second endpoint and associated with said selected communication server.

9. The method of claim 1, further comprising:
if the determination is negative:
request establishment of a communication address representing said second end point and associated with at least one of said communication servers to which said first end point has access;
receive at least one established communication address representing said second end point and associated with at least one of said servers; and
transmit data from said first end point using a received address representing said second endpoint and a communication server with which said received address is associated.

10. The method of claim 1, wherein said one or more communication servers includes a plurality of communication servers and said one or more communication addresses includes a plurality of communication addresses.

11. A computer system for transferring data between a first endpoint and a second endpoint in a network, the first end point having access to one or more communication servers for sending data and the second end point being represented by one or more communication addresses associated with one or more communication servers, the system comprising:
a first computer representing said first endpoint,
a second computer representing said second endpoint,
one or more communication servers, and wherein:
said first computer includes at least one processor and a computer readable medium upon which is stored instructions executable by said processor, enabling the processor to:
receive one or more communication addresses representative of the second end point computer;
determine whether at least one of said received communication addresses is associated with a communication server to which said first endpoint computer has access;
if the determination is positive, select a communication server to which said first end point computer has access and a communication address which is associated with said selected communication server, and transmit data from said first end point using said selected communication server and said selected communication address.

12. The system of claim 11, wherein said computer readable medium further includes instructions executable by said processor, enabling the processor to:
if the determination is negative:
request access for said first end point computer to at least one of said communication servers with which at least one of said received addresses is associated; and
if access is granted, transmit data from said first end point computer using a selected communication server to which access has been granted and a communication address representing said second endpoint computer and associated with said selected communication.

13. The system of claim 11, wherein said computer readable medium further includes instructions executable by said processor, enabling the processor to:
if the determination is negative:
request establishment of a communication address representing said second end point computer and associated with at least one of said communication servers to which said first end point has access;
receive at least one established communication address representing said second end point computer and associated with at least one of said servers; and
transmit data from said first end point computer using a received address representing said second endpoint computer and a communication server with which said received address is associated.

14. The system of claim 11, further comprising:
at least one administrative server computer with at least one processor and a computer readable medium upon which is stored instructions executable by said processor, enabling the processor to:
receive data identifying a first endpoint computer and a second endpoint computer;
perform at least one of:
identifying a communication server with which said second endpoint has an associated address for receiving data, and providing access from said first endpoint computer to said communication server for sending data;
identifying a communication server to which said first endpoint computer has access for sending data, and providing said second endpoint computer with an address associated with said server for receiving data; and
selecting a communication server, providing said first endpoint computer with access to said selected communication server for sending data and providing said second endpoint computer with an address associated with said selected communication server for receiving data.
